(19) United States
(12) Patent Application Publication
(10) Pub. No.: US 2024/0258682 A1
(43) Pub. Date: Aug. 1, 2024

(54) APPARATUS, SYSTEM, AND METHOD FOR EMBEDDING METAL MESH ANTENNAS INTO TRANSPARENT CONDUCTIVE LAYERS OF OPTICAL DEVICES

(71) Applicant: Meta Platforms Technologies, LLC, Menlo Park, CA (US)

(72) Inventors: Boon Shiu, Palo Alto, CA (US); Yasuo Morimoto, Cupertino, CA (US); Jiang Zhu, Cupertino, CA (US); Afsoon Jamali, Issaquah, WA (US)

(21) Appl. No.: 18/484,003

(22) Filed: Oct. 10, 2023

Related U.S. Application Data
(60) Provisional application No. 63/481,805, filed on Jan. 27, 2023.

(51) Int. Cl. H01Q 1/22; G02B 27/01; H01Q 1/24

(52) U.S. Cl. CPC H01Q 1/2283; G02B 27/0172; H01Q 1/24; H01Q 1/40

(57) ABSTRACT

A circuit package may comprise (1) a substrate, (2) at least one radio frequency (RF) circuit disposed on the substrate, and (3) a plurality of screw holes that are incorporated into the substrate and configured to support mounting the substrate to an enclosure, wherein at least one of the screw holes is further configured to provide at least one supplemental function in connection with the RF circuit. Various other apparatuses, systems, and methods are also disclosed.

### PRIORITY CLAIM

This non-provisional application claims priority to provisional U.S. Application No. 63/481,805 filed 27 Jan. 2023, the disclosure of which is incorporated in its entirety by this reference.

### BRIEF DESCRIPTION OF DRAWINGS

The accompanying Drawings illustrate a number of exemplary embodiments and are parts of the specification. Together with the following description, the Drawings demonstrate and explain various principles of the instant disclosure.

FIG. 1 is an illustration of an exemplary optical device that includes metal mesh antennas embedded into transparent conductive layers according to one or more embodiments of this disclosure.

FIG. 2 is an illustration of an exemplary metal mesh that serves as an antenna for an optical device according to one or more embodiments of this disclosure.

FIG. 3 is an illustration of an exemplary metal mesh that serves as an antenna for an optical device according to one or more embodiments of this disclosure.

FIG. 4 is an illustration of an exemplary optical device that includes metal mesh antennas embedded into transparent conductive layers according to one or more embodiments of this disclosure.

FIG. 5 is an illustration of an exemplary system that includes metal mesh antennas embedded into transparent conductive layers according to one or more embodiments of this disclosure.

FIG. 6 is an illustration of an exemplary head-mounted display (HMD) that includes metal mesh antennas embedded into transparent conductive layers according to one or more embodiments of this disclosure.

FIG. 7 is a flowchart of an exemplary method for embedding metal mesh antennas into transparent conductive layers of optical devices according to one or more embodiments of this disclosure.

FIG. 8 is an illustration of exemplary augmented-reality system that may be used in connection with embodiments of this disclosure.

FIG. 9 is an illustration of an exemplary virtual-reality system that may be used in connection with embodiments of this disclosure.

FIG. 10 is an illustration of exemplary haptic devices that may be used in connection with embodiments of this disclosure.

FIG. 11 is an illustration of an exemplary virtual-reality environment according to embodiments of this disclosure.

FIG. 12 is an illustration of an exemplary augmented-reality environment according to embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for embedding metal mesh antennas into transparent conductive layers of optical devices. As will be explained in greater detail below, these apparatuses, systems, and methods may provide numerous features and benefits.

In some examples, optical devices (such as HMDs) may include and/or contain a dimming layer and a transparent layer. In such examples, the dimming layer may include and/or represent an electrochromic feature that modifies an optical characteristic (such as tint, shade, contrast, clarity, and/or transparency), and/or the transparent layer may include and/or represent indium tin oxide (ITO) films that both convey light and provide electrical conductivity. In one example, designers of such optical devices may want to implement antennas for wireless communications in the transparent layer to conserve space and/or to conform to a small and/or desired form factor. Unfortunately, the ITO may be unsuitable and/or impractical as a radiating antenna element due to certain shortcomings and/or deficiencies. For example, the ITO may impart and/or provide a relatively high resistivity that renders complex antenna geometries and/or tri-band designs unworkable and/or unattainable.

Accordingly, to overcome such shortcomings and/or deficiencies, some optical devices may include and/or implement metal meshes that are embedded and/or integrated into ITOs. In some examples, such metal meshes may serve and/or function as radiating antenna elements that reduce the resistivity of the dimming and/or transparent layers in the optical devices. As a result, the optical devices may also be able to achieve and/or implement more complex antenna geometries and/or tri-band antenna designs.

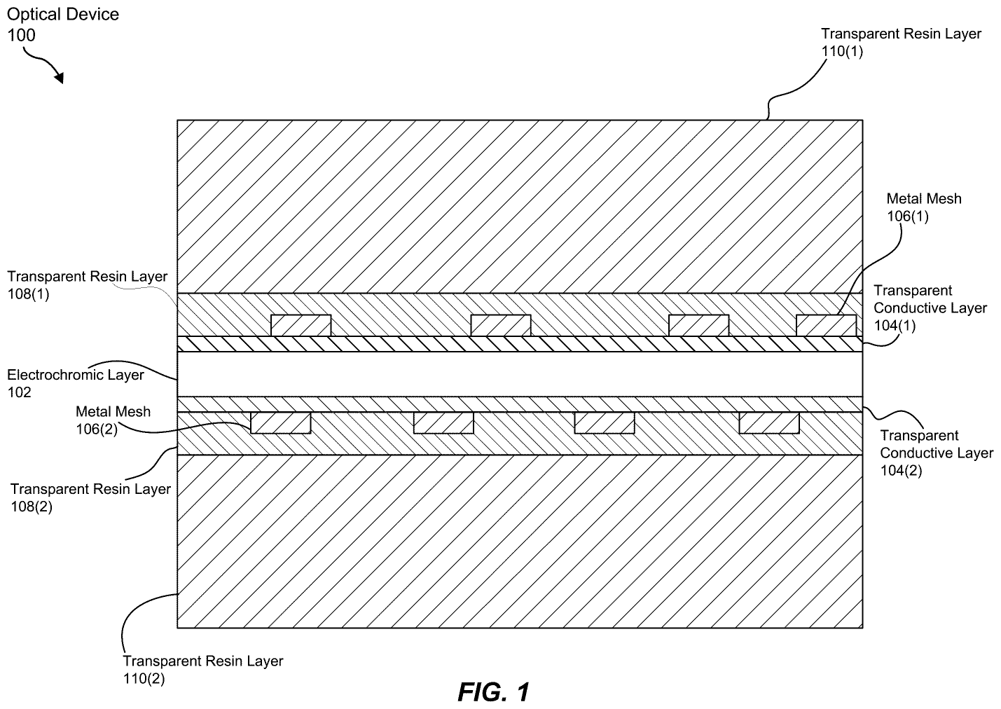

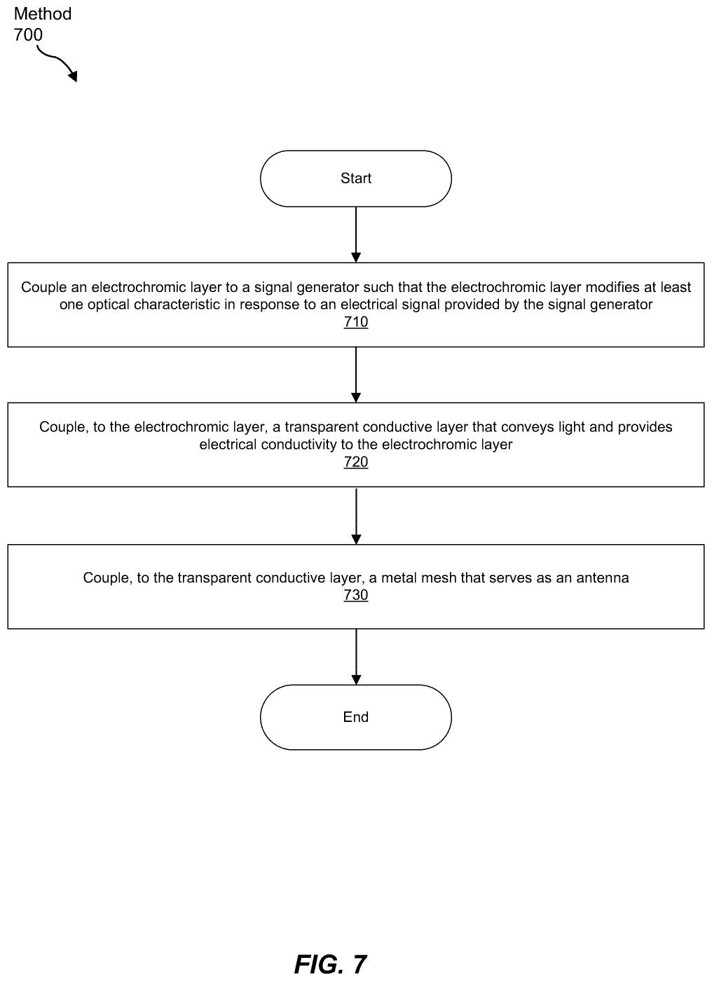

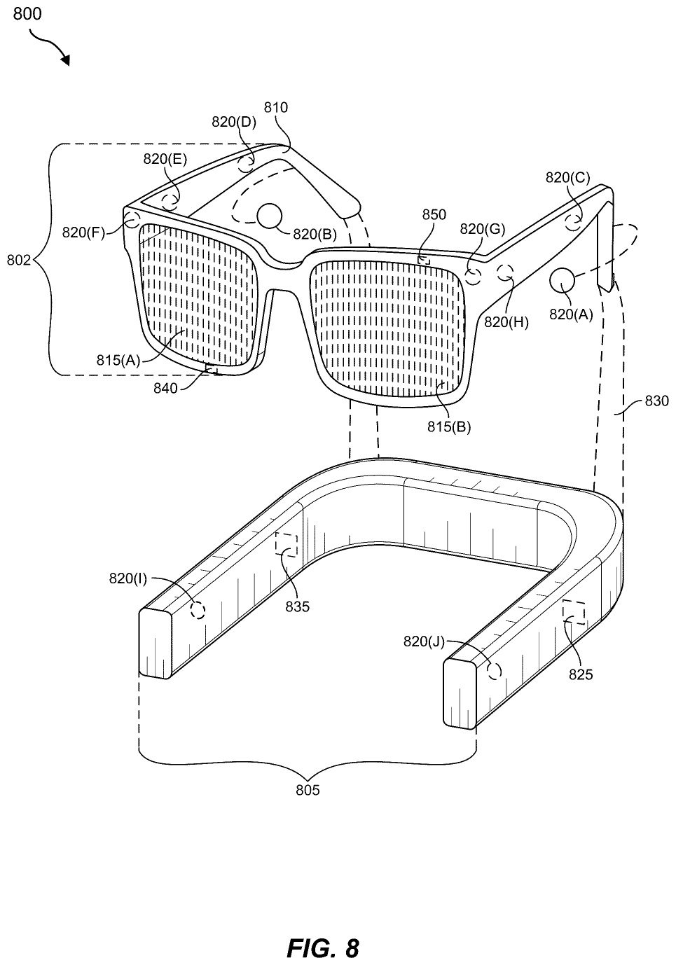

The following will provide, with reference to FIGS. 1-6, detailed descriptions of exemplary devices, systems, components, and corresponding configurations for embedding metal mesh antennas into transparent conductive layers of optical devices. In addition, detailed descriptions of methods for embedding metal mesh antennas into transparent conductive layers of optical devices in connection with FIG. 7. The discussion corresponding to FIGS. 8-12 will provide detailed descriptions of types of exemplary artificial-reality devices, wearables, and/or associated systems capable of embedding metal mesh antennas into transparent conductive layers of optical devices.

FIG. 1 illustrates a portion of an exemplary optical device 100 that includes and/or represents a metal mesh antenna embedded into a transparent conductive layer. In some examples, optical device 100 may include and/or represent an electrochromic layer 102, one or more transparent conductive layers 104(1) and 104(2), and/or one or more metal meshes 106(1) and 106(2). In one example, optical device 100 may also include and/or represent one or more transparent resin layers that combine and/or integrate with electrochromic layer 102, transparent conductive layers 104(1) and 104(2), and/or metal meshes 106(1) and (2) to form and/or establish an optical stack, lens, and/or film. As will be described in greater detail below, some or all of the features illustrated and/or labelled in FIG. 1 may be implemented, presented, and/or disposed together as an optical film (such as an ITO film) that combines the dimmer and antenna features or layers for an HMD.

In some examples, electrochromic layer 102 may be configured and/or designed to modify, adjust, and/or change one or more optical characteristics in response to an electrical signal. For example, electrochromic layer 102 may modify, adjust, and/or change the color, shade, contrast, opacity, transparency, and/or translucency of optical device 100 based at least in part on an electrical stimulus applied to electrochromic layer 102. In one example, electrochromic layer 102 may include and/or represent electrochromic material integrated and/or incorporated into the lenses and/or optical path of an augmented-reality (AR) device. In this example, electrochromic layer 102 may enable the AR device to tint, shade, and/or darken its lenses and/or optical path so as to mitigate and/or filter the amount, brightness, and/or intensity of light (e.g., sunlight) that reaches a user's eyes via the lenses and/or optical path. Accordingly, electrochromic layer 102 may serve and/or function as a sunglass feature that filters, limits, and/or blocks certain optical parameters (e.g., brightness, frequency ranges, intensity levels, etc.) of light passing and/or transmitted through the lenses and/or optical path of the AR device.

In some examples, electrochromic layer 102 may include and/or represent any type or form of material, substance, coating, and/or film characterized by one or more optical attributes and/or parameters change in response to the application of an electrical signal and/or stimulus. In one example, electrochromic layer 102 may be applied to and/or aligned with see-through lenses and/or the optical path of an AR device. For example, electrochromic layer 102 may be disposed and/or applied as a part of and/or inside a film coupled to one or more see-through lenses of an AR device.

In some examples, electrochromic layer 102 may be of any suitable size and/or dimensions. In one example, electrochromic layer 102 may be dimensioned to span and/or cover some or all of the visible area, plane, and/or region of one or more see-through lenses installed to an AR device. Additionally or alternatively, electrochromic layer 102 may include and/or represent multiple subsections that are independently controllable and/or programmable via one or more electrical signals and/or stimuli. For example, electrochromic layer 102 may include and/or represent a first subsection of electrochromic material disposed along a top region of one or more see-through lenses installed to an AR device and a second subsection of electrochromic material disposed along a bottom region of the see-through lenses installed to the AR device. In this example, the AR device may modify and/or adjust one or more optical characteristics of the top region and/or bottom region of the see-through lenses independently of one another. As a specific example, the AR device may darken only the top region of the see-through lenses without doing the same to the bottom region of the see-through lenses.

In some examples, transparent conductive layers 104(1) and 104(2) may each be configured and/or designed to provide and/or accomplish multiple purposes and/or functionalities. For example, transparent conductive layers 104(1) and 104(2) may each convey and/or transmit light (e.g., sunlight) and also provide and/or facilitate electrical conductivity or continuity. In one example, transparent conductive layers 104(1) and 104(2) may be disposed with and/or applied to one or more metal mesh antennas to facilitate and/or support the transfer of radio-frequency (RF) signals transmitted and/or received by the metal mesh antennas. In this example, transparent conductive layers 104(1) and 104(2) may also provide, support, and/or facilitate a high degree optical transmissivity and/or transmissibility for a user of an AR device so as to avoid impairing the user's vision and/or visibility via the AR device.

In some examples, one or more of transparent conductive layers 104(1) and 104(2) may communicate, carry, and/or convey an RF signal generated by an RF integrated circuit (RFIC) of an AR device to a metal mesh antenna for wireless transmission. Additionally or alternatively, one or more of transparent conductive layers 104(1) and 104(2) may communicate, carry, and/or convey an RF signal received by a metal mesh antenna to an RFIC of an AR device for processing.

In some examples, transparent conductive layers 104(1) and 104(2) may each include and/or represent any type or form of material, substance, coating, and/or film that provides and/or facilitates both optical transmissivity and electrical conductivity. Examples of materials used to form transparent conductive layers 104(1) and 104(2) include, without limitation, ITOs, transparent conductive oxides, conductive polymers, carbon nanotubes, graphene, graphite, silver nano wire (SNW), indium zinc oxide (IZO), silver alloys, silver ITO alloys, silver IZO alloys, combinations or variations of one or more of the same, and/or any other suitable materials.

In one example, transparent conductive layers 104(1) and 104(2) may each include and/or represent ITO layers and/or films that are physically coupled to, applied to, and/or disposed on opposing sides of electrochromic layer 102. In this example, one or more of these ITO layers and/or films may be electrically and/or communicatively coupled and/or connected to electrochromic layer 102. In certain implementations, one or more of transparent conductive layers 104(1) and 104(2) may be disposed and/or applied as a part of and/or inside a film coupled to one or more see-through lenses of an AR device. In such implementations, this film may also include and/or incorporate electrochromic layer 102.

In some examples, transparent conductive layers 104(1) and 104(2) may be of any suitable size and/or dimensions. In one example, transparent conductive layers 104(1) and 104(2) may be dimensioned to span and/or cover some or all of the visible area, plane, and/or region of one or more see-through lenses installed to an AR device. Additionally or alternatively, transparent conductive layers 104(1) and 104(2) may each include and/or represent a plane and/or various traces inside a combinational film that serves as both dimmer and one or more antennas for the AR device. For example, transparent conductive layers 104(1) and 104(2) may individually and/or collectively carry or convey electrical signals and/or stimuli that control the dimming of electrochromic layer 102 and excite metal mesh antennas for wireless communications.

In some examples, metal meshes 106(1) and 106(2) may each be configured and/or designed to serve and/or function as an antenna for transmitting and/or receiving RF signals. For example, metal meshes 106(1) and 106(2) may each be electrically and/or communicatively coupled between an RFIC of an AR device and electrodes of transparent conductive layers 104(1) and 104(2), respectively. In one example, metal meshes 106(1) and 106(2) may reduce and/or decrease the resistivity of those electrodes to enable and/or maintain the functionalities of electrochromic layer 102 and/or transparent conductive layers 104(1) and 104(2). Additionally or alternatively, metal meshes 106(1) and 106(2) may increase and/or improve the structural integrity of those electrodes to facilitate and/or accommodate the potential deformation of transparent conductive layers 104(1) and 104(2).

In some examples, metal meshes 106(1) and 106(2) may each receive RF signals from the RFIC via transparent conductive layers 104(1) and 104(2), respectively, and then wirelessly transmit those RF signals to a remote device. Additionally or alternatively, metal meshes 106(1) and 106(2) may each wirelessly receive RF signals from the remote device and then forward those RF signals to the RFIC via transparent conductive layers 104(1) and 104(2), respectively. In one example, metal mesh 106(1) may be configured to operate as the antenna for a primary radio system of an AR device. In this example, metal mesh 106(2) may be configured to operate as the antenna for a secondary radio system of the AR device. In certain implementations, the primary and secondary radio systems may operate at different frequencies and/or ranges relative to one another. Additionally or alternatively, the primary and secondary radio systems may operate at the same frequencies and/or ranges or even transmit the same RF signals.

In some examples, metal meshes 106(1) and 106(2) may be integrated and/or embedded into transparent conductive layers 104(1) and 104(2), respectively. For example, metal meshes 106(1) and 106(2) may be physically coupled to, applied to, and/or disposed on transparent conductive layers 104(1) and 104(2), respectively. Additionally or alternatively, metal meshes 106(1) and 106(2) may be electrically and/or communicatively coupled and/or connected to transparent conductive layers 104(1) and 104(2), respectively. In certain implementations, one or more of metal meshes 106(1) and 106(2) and transparent conductive layers 104(1) and 104(2) may be disposed and/or applied as a part of and/or inside a film coupled to one or more see-through lenses of an AR device. In such implementations, this film may also include and/or incorporate electrochromic layer 102.

In some examples, metal meshes 106(1) and 106(2) may each include and/or represent any type or form of material and/or substance capable of radiating RF energy for transmitting and/or receiving RF communications. Examples of materials used to form metal meshes 106(1) and 106(2) include, without limitation, coppers, aluminums, steels, stainless steels, silvers, golds, combinations or variations of one or more of the same, and/or any other suitable materials.

In some examples, metal meshes 106(1) and 106(2) may each include and/or represent a network of wires and/or threads. In one example, metal meshes 106(1) and 106(2) may each include and/or represent lattices and/or webbings of similar, identical, varied, gradient, and/or random sizes. For example, metal meshes 106(1) and 106(2) may each include and/or form various honeycomb-shaped lattices and/or structures that are nearly invisible to the naked eye.

In one example, metal meshes 106(1) and 106(2) may each include and/or represent a center region and a perimeter region. In this example, metal meshes 106(1) and 106(2) may each exhibit and/or demonstrate a gradation of mesh density and/or structure size from the center region to the perimeter region. For example, the perimeter region of metal meshes 106(1) and 106(2) may be more densely populated with honeycomb-shaped lattices and/or structures than the center region metal meshes 106(1) and 106(2). In this example, the center region may be somewhat sparsely populated with honeycomb-shaped lattices and/or structures so as to avoid degrading the optical transmissivity of the AR device. Alternatively, the perimeter region may include and/or represent a solid or semi-solid border that outlines and/or encompasses the center region. Accordingly, metal meshes 106(1) and 106(2) may each exhibit and/or represent gradients of lattices and/or structures from the center region to the perimeter region.

In some examples, metal meshes 106(1) and 106(2) may be of any suitable size and/or dimensions. In one example, metal meshes 106(1) and 106(2) may be dimensioned to span and/or cover some or all of the visible area, plane, and/or region of one or more see-through lenses installed to an AR device. Additionally or alternatively, metal meshes 106(1) and 106(2) may each span and/or cover certain areas, planes, and/or regions outside the optical path of the AR device. For example, the perimeter region of metal meshes 106(1) and 106(2) may reach and/or be positioned outside the view of a user wearing the AR device.

In some examples, transparent resin layers 108(1) and 108(2) may cover and/or be applied over metal meshes 106(1) and 106(2), respectively, opposite transparent conductive layers 104(1) and 104(2), respectively. In such examples, portions of transparent resin layers 108(1) and 108(2) may touch and/or make contact with transparent conductive layers 104(1) and 104(2), respectively, in locations where openings and/or holes form through the honeycomb-shaped lattices and/or structures of metal meshes 106(1) and 106(2). In one example, transparent resin layers 108(1) and 108(2) may secure, hold, and/or maintain metal meshes 106(1) and 106(2) against transparent conductive layers 104(1) and 104(2), respectively.

In some examples, transparent resin layers 110(1) and 110(2) may be physically coupled and/or attached to transparent conductive layers 108(1) and 108(2), respectively, opposite metal meshes 106(1) and 106(2), respectively. In one example, transparent resin layer 110(1) may be physically and/or optically coupled to a lens of optical device 100 and/or an AR device. In this example, transparent resin layer 110(2) may be physically and/or optically coupled to a display screen.

In some examples, transparent resin layers 108(1) and 110(1) may include and/or contain materials and/or compositions that differ from one another. Similarly, transparent resin layers 108(2) and 110(2) may include and/or contain materials and/or compositions that differ from one another. In one example, transparent resin layers 110(1) and 110(2) may each include and/or represent polyethylene terephthalate (PET) material and/or compositions.

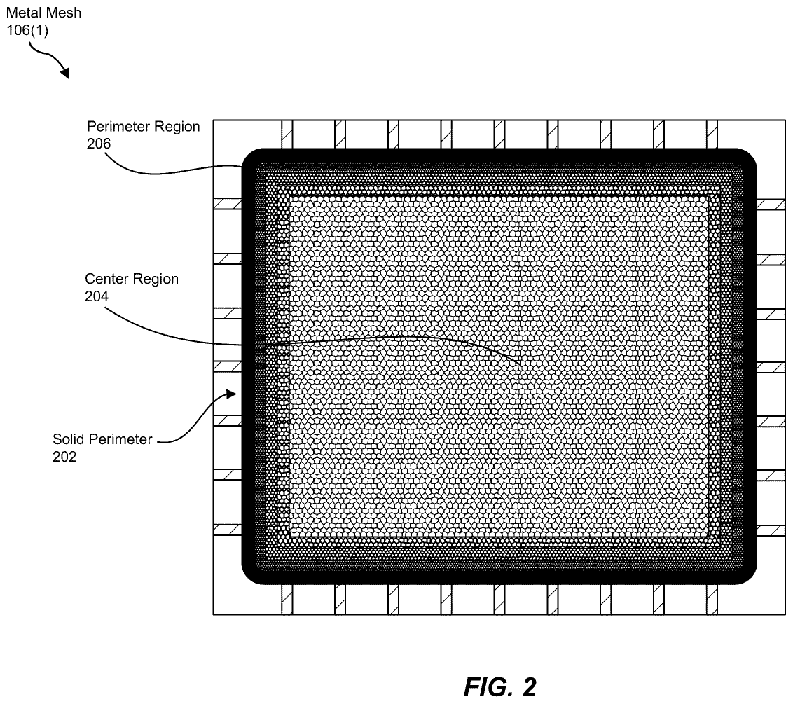

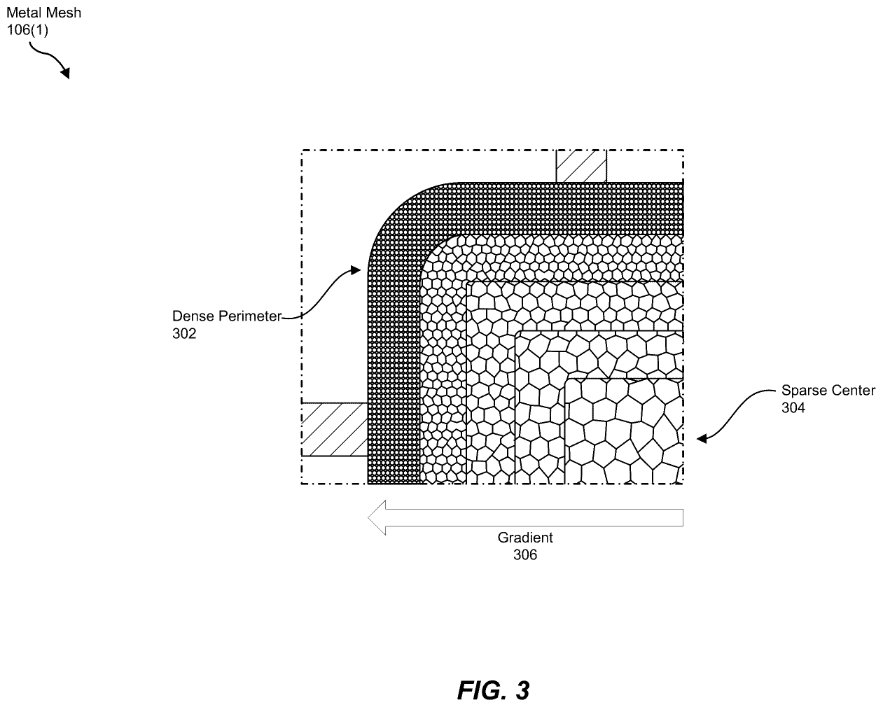

FIGS. 2 and 3 illustrate exemplary implementations of metal mesh 106(1). In some examples, metal mesh 106(1) may include and/or represent certain components, configurations, and/or features that perform and/or provide functionalities that are similar and/or identical to those described above in connection with FIG. 1. As illustrated in FIG. 2, exemplary metal mesh 106(1) may include and/or represent a center region 204 and a perimeter region 206. In one example, perimeter region 206 may include and/or represent a solid perimeter 202.

In some examples, both center region 204 and perimeter region 206 may include and/or represent a network of randomized honeycomb-shaped lattices and/or structures. In one example, center region 204 may include and/or represent honeycomb-shaped lattices and/or structures that are larger and/or more loosely interconnected than those included and/or represented by perimeter region 206. Conversely, perimeter region 206 may include and/or represent honeycomb-shaped lattices and/or structures that are smaller and/or more tightly interconnected than those included and/or represented by perimeter region 206.

As illustrated in FIG. 3, exemplary metal mesh 106(1) may include and/or represent a dense perimeter 302 with tightly interconnected lattices and/or structures that appear to form a completely or nearly solid border. Additionally or alternatively, exemplary metal mesh 106(1) may include and/or represent a sparse center 304 with loosely interconnected lattices and/or structures that appear to form a random pattern. In some examples, metal mesh 106(1) may exhibit a gradient 106 and/or gradation of mesh density form sparse center 304 to dense perimeter 302. In one example, gradient 106 may include and/or represent various degrees of mesh density between sparse center 304 and dense perimeter 302.

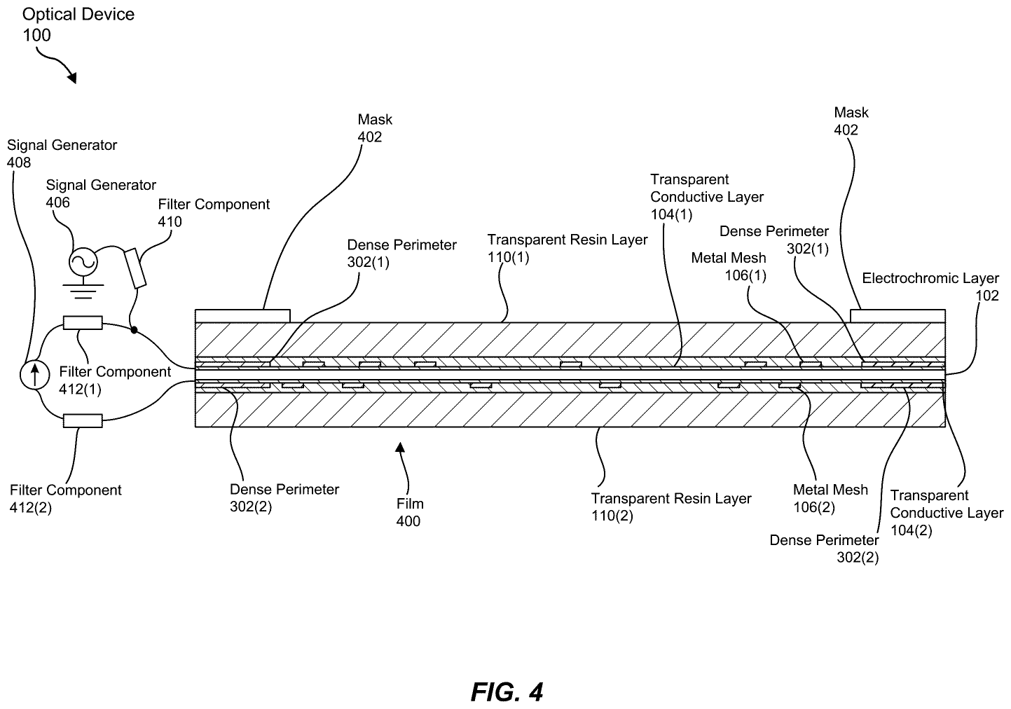

FIG. 4 illustrates an exemplary optical device 100, such as an HMD, that includes metal mesh antennas embedded into transparent conductive layers. In some examples, optical device 100 may include and/or represent certain components, configurations, and/or features that perform and/or provide functionalities that are similar and/or identical to those described above in connection with any of FIGS. 1-3. As illustrated in FIG. 4, exemplary optical device 100 may include and/or represent a film 400 composed of electrochromic layer 102, transparent conductive layers 104(1) and 104(2), metal meshes 106(1) and 106(2), transparent resin layers 108(1) and 108(2), and/or transparent resin layers 110(1) and 110(2).

In some examples, film 400 may be installed, incorporated, and/or implemented in an AR device. In such examples, metal meshes 106(1) and 106(2) may be positioned and/or situated in the AR device such that dense perimeters 302(1) and 302(2) are obfuscated and/or obscured behind mask 402 of the AR device. In one example, mask 402 may include and/or represent a portion of an enclosure and/or frame of the AR device. Accordingly, dense perimeters 302(1) and 302(2) may be at least partially aligned with mask 402 such that dense perimeters 302(1) and 302(2) are at least partially obfuscated and/or obscured from view of the user when the AR device is worn by the user.

In some examples, transparent conductive layers 104(1) and 104(2) may be electrically and/or communicatively coupled to certain electronics and/or RF circuitry. For example, optical device 100 may include and/or represent a signal generator 406 that is electrically and/or communicatively coupled to transparent conductive layer 104(1) via a filter component 410. In this example, signal generator 406 may provide and/or transmit an RF signal to metal mesh 106(1) via transparent conductive layer 104(1). This RF signal may be wirelessly transmitted by metal mesh 106(1) to a remote device.

As another example, optical device 100 may also include and/or represent a signal generator 408 that is electrically and/or communicatively coupled to transparent conductive layer 104(1) via a filter component 412(1) and/or to transparent conductive layer 104(2) via a filter component 412(2). In this example, signal generator 408 may provide and/or transmit an electrical signal to electrochromic layer 102 via one or more of transparent conductive layers 104(1) or 104(2). This electrical signal may control certain optical characteristics of electrochromic layer 102.

In some examples, filter component 410 may include and/or represent a capacitor that is configured and/or installed to decouple and/or filter the RF signal provided by signal generator 406 from the electrical signal provided by signal generator 408. In certain examples, filter components 412(1) and 412(2) may include and/or represent inductors that are configured and/or installed to decouple and/or filter the electrical signal provided by signal generator 408 from the RF signal provided by signal generator 406.

In some examples, signal generator 406 and/or signal generator 408 may constitute and/or represent part of an integrated circuit (such as an RFIC, a microcontroller, and/or a processor). In one example, signal generator 406 may produce and/or provide an oscillating and/or alternating-current (AC) signal in the RF range. In this example, signal generator 408 may produce and/or provide a biasing and/or direct-current (DC) signal. Additionally or alternatively, signal generator 408 may produce and/or provide an oscillating signal and/or AC signal of a much lower frequency than the RF signal produced and/or provided by signal generator 406.

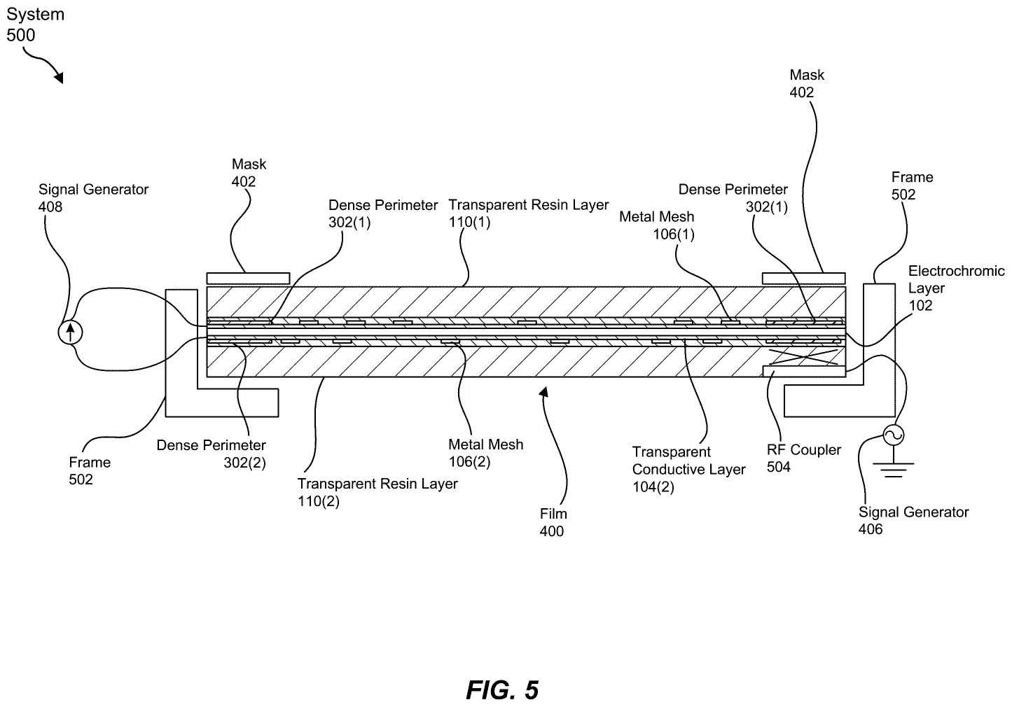

FIG. 5 illustrates an exemplary system 500, such as an HMD, that includes metal mesh antennas embedded into transparent conductive layers. In some examples, system 500 may include and/or represent certain components, configurations, and/or features that perform and/or provide functionalities that are similar and/or identical to those described above in connection with any of FIGS. 1-4. As illustrated in FIG. 5, exemplary system 500 may include and/or represent film 400 composed of electrochromic layer 102, transparent conductive layers 104(1) and 104(2), metal meshes 106(1) and 106(2), transparent resin layers 108(1) and 108(2), and/or transparent resin layers 110(1) and 110(2). In some examples, film 400 may be installed, incorporated, and/or implemented in a frame 502 of an AR device.

In some examples, signal generator 406 may be electromagnetically and/or communicatively coupled to transparent conductive layer 104(1) or 104(2) via an RF coupler 504 (e.g., a directional coupler, a hybrid coupler, an RF power tap, etc.). In this example, signal generator 406 may provide and/or transmit an RF signal to metal mesh 106(1) via RF coupler 504. This RF signal may be wirelessly transmitted by metal mesh 106(1) to a remote device.

As another example, signal generator 408 may be electrically and/or communicatively coupled to transparent conductive layer 104(1) or 104(2). In this example, signal generator 408 may provide and/or transmit an electrical signal to electrochromic layer 102 via one or more of transparent conductive layers 104(1) or 104(2). This electrical signal may control certain optical characteristics of electrochromic layer 102.

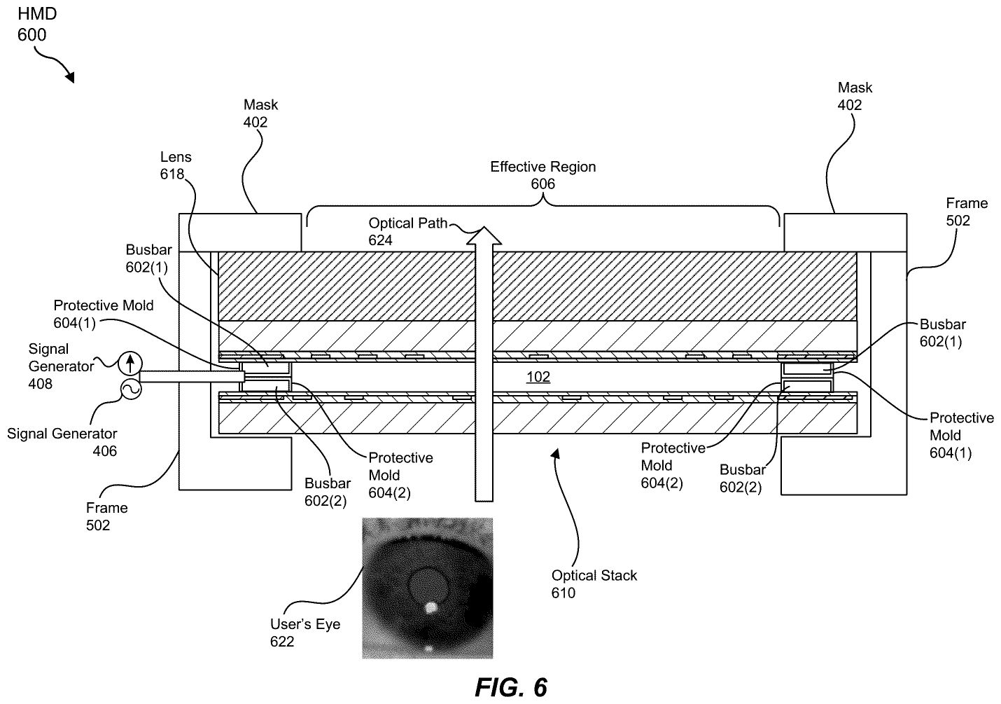

FIG. 6 illustrates an exemplary HMD 600 that includes metal mesh antennas embedded into transparent conductive layers. In some examples, HMD 600 may include and/or represent certain components, configurations, and/or features that perform and/or provide functionalities that are similar and/or identical to those described above in connection with any of FIGS. 1-5. As illustrated in FIG. 6, exemplary HMD 600 may include and/or represent an optical stack 610 composed of electrochromic layer 102, transparent conductive layers 104(1) and 104(2), metal meshes 106(1) and 106(2), transparent resin layers 108(1) and 108(2), transparent resin layers 110(1) and 110(2), and/or a lens 618. In some examples, optical stack 610 may be installed, incorporated, and/or implemented in frame 502 of HMD 600.

In some examples, optical stack 610 may also include and/or contain one or more busbars 602(1) and 602(2) that electrically and/or communicatively couple transparent conductive layers 104(1) and 104(2), respectively, to electrochromic layer 102. Additionally or alternatively, busbars 602(1) and 602(2) may electrically and/or communicatively couple signal generator 406 or 408 to transparent conductive layers 104(1) and 104(2) and/or to electrochromic layer 102.

In one example, busbars 602(1) and 602(2) may each include and/or be made of a carbon-based substance and/or compound that exhibits resistance to oxidation. In this example, the oxidation-resistant, carbon-based substance may include and/or represent graphene and/or graphite. In another example, busbars 602(1) and 602(2) may include and/or be made of a silver-based substance and/or compound that is at least partially encased and/or covered by protective molds 604(1) and 604(2), respectively. In this example, the protective mold may prevent the silver-based substance and/or compound from oxidizing.

In some examples, silver and/or graphene or graphite may be combined with bond (whether as independent layers or mixed compositionally) and then printed on the edge of electrochromic layer 102 to form busbars 602(1) and 602(2). In one example, once the resistivity level of electrochromic layer 102 lowers due to the printing, busbars 602(1) and 602(2) may be reused and/or repurposed as an antenna element. This lower resistivity level may positively impact and/or improve the antenna's performance.

In some examples, HMD 600 may form and/or provide an optical path 624 for a user through optical stack 610. In one example, optical path 624 may include and/or represent the field of view from the user's eye 622 to an effective region 606 defined by HMD 600. In this example, optical stack 610 may be positioned and/or placed in optical path 624 of the user. In certain implementations, the positioning and/or placement of optical stack 610 in optical path 624 may enable the user to see through at least a portion of optical stack 610 when HMD 600 is worn on and/or mounted to the head of the user. Additionally or alternatively, optical stack 610 may support and/or facilitate viewing of computer-generated content in optical path 624 of the user.

FIG. 7 is a flow diagram of an exemplary method 700 for embedding metal mesh antennas into transparent conductive layers of optical devices. In one example, the steps shown in FIG. 7 may be performed during the manufacture and/or assembly of an optical device, an HMD, and/or an AR device. Additionally or alternatively, the steps shown in FIG. 7 may incorporate and/or involve various sub-steps and/or variations consistent with one or more of the descriptions provided above in connection with FIGS. 1-6.

As illustrated in FIG. 7, method 700 may include and/or involve the step of coupling an electrochromic layer to an electrical signal such that the electrochromic layer modifies at least one optical characteristic in response to the electrical signal (710). Step 710 may be performed in a variety of ways, including any of those described above in connection with FIGS. 1-6. For example, an HMD manufacturer or subcontractor may electrically and/or communicatively couple an electrochromic layer to an electrical signal such that the electrochromic layer modifies at least one optical characteristic in response to the electrical signal.

In some examples, method 700 may also include the step of coupling, to the electrochromic layer, a transparent conductive layer that conveys light and provides electrical conductivity to the electrochromic layer (720). Step 720 may be performed in a variety of ways, including any of those described above in connection with FIGS. 1-6. For example, the HMD manufacturer or subcontractor may electrically and/or communicatively couple a transparent conductive layer to the electrochromic layer. In this example, the transparent conductive layer may both convey light and provide electrical conductivity to the electrochromic layer.

In some examples, method 700 may further include the step of coupling, to the transparent conductive layer, a metal mesh that serves as an antenna (730). Step 730 may be performed in a variety of ways, including any of those described above in connection with FIGS. 1-6. For example, the HMD manufacturer or subcontractor may electrically and/or communicatively couple a metal mesh to the transparent conductive layer. In this example, the metal mesh may serve and/or function as an antenna.

### EXAMPLE EMBODIMENTS

Example 1: A optical device comprising (1) an electrochromic layer configured to modify at least one optical characteristic in response to an electrical signal, (2) a transparent conductive layer coupled to the electrochromic layer, wherein the transparent conductive layer is configured to convey light and provide electrical conductivity, and (3) a metal mesh coupled to the transparent conductive layer, wherein the metal mesh is configured to serve as an antenna.

Example 2: The optical device of Example 1, wherein the transparent conductive layer is coupled between the electrochromic layer and the metal mesh.

Example 3: The optical device of either Example 1 or Example 2, further comprising at least one transparent resin layer applied to the metal mesh and the transparent conductive layer.

Example 4: The optical device of any of Examples 1-3, further comprising a transparent film that includes the transparent conductive layer and the metal mesh.

Example 5: The optical device of any of Examples 1-4, wherein the transparent film further includes the electrochromic layer.

Example 6: The optical device of any of Examples 1-5, wherein at least a portion of the metal mesh is embedded into an electrode of the transparent conductive layer.

Example 7: The optical device of any of Examples 1-6, wherein the metal mesh reduces resistivity of the electrode.

Example 8: The optical device of any of Examples 1-7, wherein the metal mesh increases structural integrity of the electrode.

Example 9: The optical device of any of Examples 1-8, further comprising (1) a signal generator coupled to the transparent conductive layer, wherein the signal generator is configured to transmit the electrical signal to electrochromic layer via the transparent conductive layer, and (2) an additional signal generator coupled to a radio-frequency (RF) coupler, wherein the additional signal generator is configured to transmit an RF signal to the metal mesh via the RF coupler.

Example 10: The optical device of any of Examples 1-9, further comprising (1) a signal generator coupled to the transparent conductive layer, wherein the signal generator is configured to transmit the electrical signal to the electrochromic layer via the transparent conductive layer, (2) an additional signal generator coupled to the transparent conductive layer, wherein the additional signal generator is configured to transmit an RF signal to the metal mesh via the transparent conductive layer, (3) a filter component coupled between the signal generator and the transparent conductive, wherein the filter component is configured to decouple the signal generator from the RF signal, and (4) an additional filter component coupled between the additional signal generator and the transparent conductive, wherein the additional filter component is configured to decouple the additional signal generator from the electrical signal.

Example 11: The optical device of any of Examples 1-10, wherein (1) the filter component comprises an inductor, and (2) the additional filter component comprises a capacitor.

Example 12: The optical device of any of Examples 1-11, wherein (1) the metal mesh comprises a center region and a perimeter region, and (2) the metal mesh exhibits a gradation of mesh density from the center region to the perimeter region.

Example 13: The optical device of any of Examples 1-12, wherein (1) an additional transparent conductive layer coupled to the electrochromic layer opposite the transparent conductive layer, wherein the additional transparent conductive layer is configured to convey light and provide electrical conductivity, and (2) an additional metal mesh coupled to the additional transparent conductive layer, wherein the additional metal mesh is configured to serve as an additional antenna.

Example 14: The optical device of any of Examples 1-13, wherein the transparent conductive layer comprises an ITO layer.

Example 15: The optical device of any of Examples 1-14, further comprising (1) a head-mounted display dimensioned to be worn by a user and (2) an optical stack coupled to a frame of the head-mounted display, the optical stack comprising the transparent conductive layer, the metal mesh, the electrochromic layer, and at least one lens, and wherein the metal mesh comprises a solid perimeter positioned to at least partially align with the frame of the head-mounted display such that the solid perimeter is at least partially obfuscated from view of the user when the head-mounted display is worn by the user.

Example 16: The optical device of any of Examples 1-15, wherein the optical stack further comprises a busbar that electrically couples the transparent conductive layer to the electrochromic layer, the busbar comprising a carbon-based substance that exhibits resistance to oxidation.

Example 17: The optical device of any of Examples 1-16, wherein the optical stack further comprises a busbar that electrically couples the transparent conductive layer to the electrochromic layer, the busbar comprising a silver contact at least partially encased by a protective mold.

Example 18: A system comprising (1) a head-mounted display dimensioned to be worn by a user and (2) an optical device coupled to the head-mounted display, the optical device comprising (A) an electrochromic layer configured to modify at least one optical characteristic in response to an electrical signal, (B) a transparent conductive layer coupled to the electrochromic layer, wherein the transparent conductive layer is configured to convey light and provide electrical conductivity, and (C) a metal mesh coupled to the transparent conductive layer, wherein the metal mesh is configured to serve as an antenna.

Example 19: The system of any of Example 18, wherein the transparent conductive layer is coupled between the electrochromic layer and the metal mesh.

Example 20: A method comprising (1) coupling an electrochromic layer to a signal generator such that the electrochromic layer modifies at least one optical characteristic in response to an electrical signal provided by the signal generator, (2) coupling, to the electrochromic layer, a transparent conductive layer that conveys light and provides electrical conductivity to the electrochromic layer, and (3) coupling, to the transparent conductive layer, a metal mesh that serves as an antenna.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

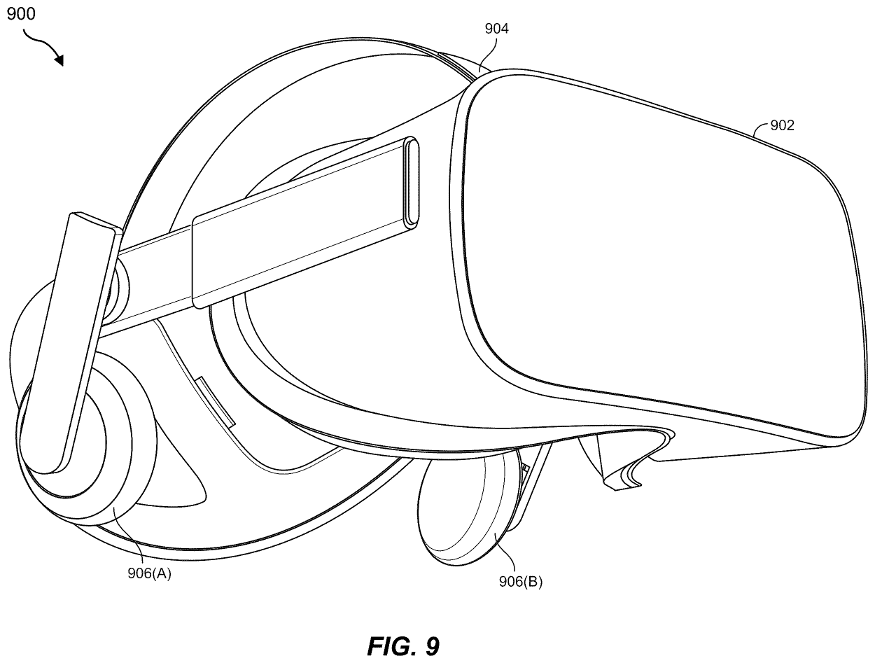

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(I) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality system 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(l) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 800 and 900 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

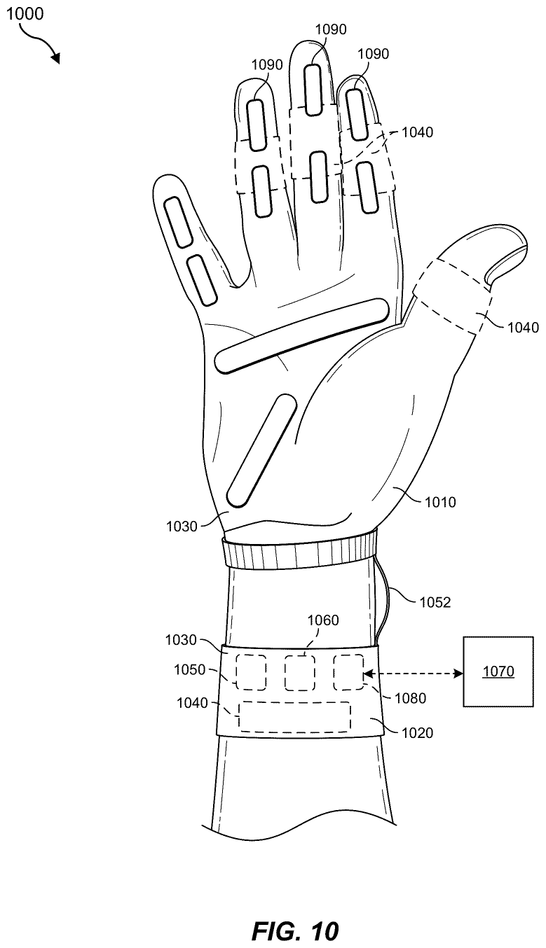

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 10 illustrates a vibrotactile system 1000 in the form of a wearable glove (haptic device 1010) and wristband (haptic device 1020). Haptic device 1010 and haptic device 1020 are shown as examples of wearable devices that include a flexible, wearable textile material 1030 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1040 may be positioned at least partially within one or more corresponding pockets formed in textile material 1030 of vibrotactile system 1000. Vibrotactile devices 1040 may be positioned in locations to provide a vibrating sensation (e.g., haptic feedback) to a user of vibrotactile system 1000. For example, vibrotactile devices 1040 may be positioned against the user's finger(s), thumb, or wrist, as shown in FIG. 10. Vibrotactile devices 1040 may, in some examples, be sufficiently flexible to conform to or bend with the user's corresponding body part(s).

A power source 1050 (e.g., a battery) for applying a voltage to the vibrotactile devices 1040 for activation thereof may be electrically coupled to vibrotactile devices 1040, such as via conductive wiring 1052. In some examples, each of vibrotactile devices 1040 may be independently electrically coupled to power source 1050 for individual activation. In some embodiments, a processor 1060 may be operatively coupled to power source 1050 and configured (e.g., programmed) to control activation of vibrotactile devices 1040.

Vibrotactile system 1000 may be implemented in a variety of ways. In some examples, vibrotactile system 1000 may be a standalone system with integral subsystems and components for operation independent of other devices and systems. As another example, vibrotactile system 1000 may be configured for interaction with another device or system 1070. For example, vibrotactile system 1000 may, in some examples, include a communications interface 1080 for receiving and/or sending signals to the other device or system 1070. The other device or system 1070 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1080 may enable communications between vibrotactile system 1000 and the other device or system 1070 via a wireless (e.g., Wi-Fi, BLUETOOTH, cellular, radio, etc.) link or a wired link. If present, communications interface 1080 may be in communication with processor 1060, such as to provide a signal to processor 1060 to activate or deactivate one or more of the vibrotactile devices 1040.

Vibrotactile system 1000 may optionally include other subsystems and components, such as touch-sensitive pads 1090, pressure sensors, motion sensors, position sensors, lighting elements, and/or user interface elements (e.g., an on/off button, a vibration control element, etc.). During use, vibrotactile devices 1040 may be configured to be activated for a variety of different reasons, such as in response to the user's interaction with user interface elements, a signal from the motion or position sensors, a signal from the touch-sensitive pads 1090, a signal from the pressure sensors, a signal from the other device or system 1070, etc.

Although power source 1050, processor 1060, and communications interface 1080 are illustrated in FIG. 10 as being positioned in haptic device 1020, the present disclosure is not so limited. For example, one or more of power source 1050, processor 1060, or communications interface 1080 may be positioned within haptic device 1010 or within another wearable textile.

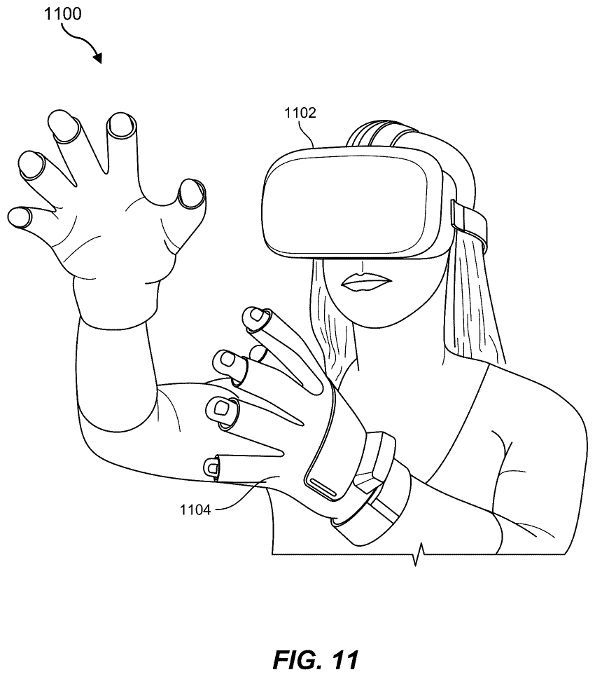

Haptic wearables, such as those shown in and described in connection with FIG. 10, may be implemented in a variety of types of artificial-reality systems and environments. FIG. 11 shows an example artificial-reality environment 1100 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1102 generally represents any type or form of virtual-reality system, such as virtual-reality system 900 in FIG. 9. Haptic device 1104 generally represents any type or form of wearable device, worn by a user of an artificial-reality system, that provides haptic feedback to the user to give the user the perception that he or she is physically engaging with a virtual object. In some embodiments, haptic device 1104 may provide haptic feedback by applying vibration, motion, and/or force to the user. For example, haptic device 1104 may limit or augment a user's movement. To give a specific example, haptic device 1104 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1104 to send action requests to a console. Examples of action requests include, without limitation, requests to start an application and/or end the application and/or requests to perform a particular action within the application.

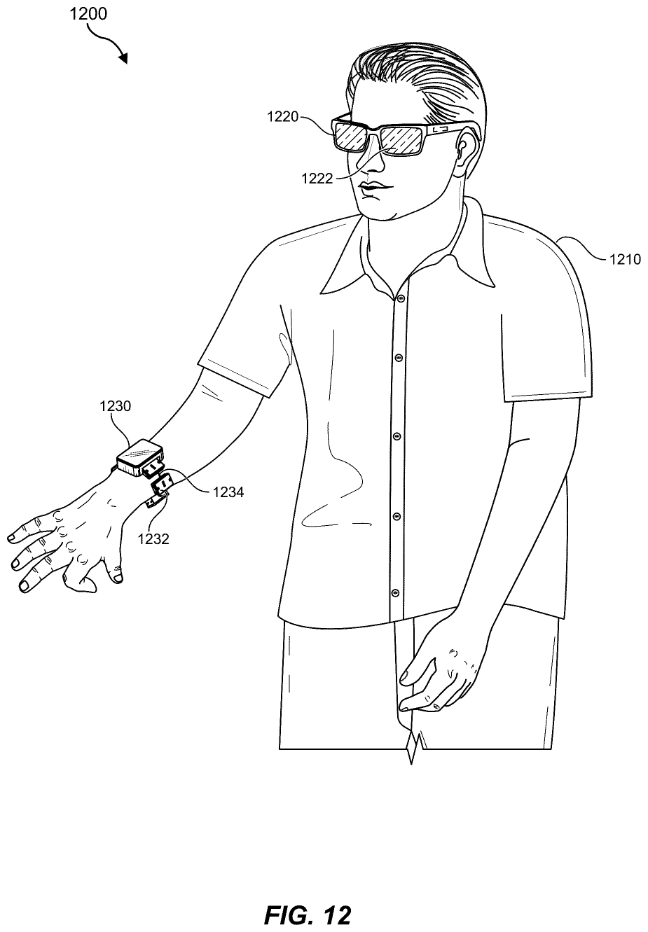

While haptic interfaces may be used with virtual-reality systems, as shown in FIG. 11, haptic interfaces may also be used with augmented-reality systems, as shown in FIG. 12. FIG. 12 is a perspective view of a user 1210 interacting with an augmented-reality system 1200. In this example, user 1210 may wear a pair of augmented-reality glasses 1220 that may have one or more displays 1222 and that are paired with a haptic device 1230. In this example, haptic device 1230 may be a wristband that includes a plurality of band elements 1232 and a tensioning mechanism 1234 that connects band elements 1232 to one another. Additionally or alternatively, haptic device 1530 may include and/or represent a haptic smartwatch and/or a smartwatch with haptic features.

One or more of band elements 1232 may include any type or form of actuator suitable for providing haptic feedback. For example, one or more of band elements 1232 may be configured to provide one or more of various types of cutaneous feedback, including vibration, force, traction, texture, and/or temperature. To provide such feedback, band elements 1232 may include one or more of various types of actuators. In one example, each of band elements 1232 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1010, 1020, 1104, and 1230 may include any suitable number and/or type of haptic transducer, sensor, and/or feedback mechanism. For example, haptic devices 1010, 1020, 1104, and 1230 may include one or more mechanical transducers, piezoelectric transducers, and/or fluidic transducers. Haptic devices 1010, 1020, 1104, and 1230 may also include various combinations of different types and forms of transducers that work together or independently to enhance a user's artificial-reality experience. In one example, each of band elements 1232 of haptic device 1230 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An optical device comprising:
an electrochromic layer configured to modify at least one optical characteristic in response to an electrical signal;
a transparent conductive layer coupled to the electrochromic layer, wherein the transparent conductive layer is configured to convey light and provide electrical conductivity; and
a metal mesh coupled to the transparent conductive layer, wherein the metal mesh is configured to serve as an antenna.

2. The optical device of claim 1, wherein the transparent conductive layer is coupled between the electrochromic layer and the metal mesh.

3. The optical device of claim 1, further comprising at least one transparent resin layer applied to the metal mesh and the transparent conductive layer.

4. The optical device of claim 1, further comprising a transparent film that includes the transparent conductive layer and the metal mesh.

5. The optical device of claim 4, wherein the transparent film further includes the electrochromic layer.

6. The optical device of claim 4, wherein at least a portion of the metal mesh is embedded into an electrode of the transparent conductive layer.

7. The optical device of claim 6, wherein the metal mesh reduces resistivity of the electrode.

8. The optical device of claim 6, wherein the metal mesh increases structural integrity of the electrode.

9. The optical device of claim 1, further comprising:
a signal generator coupled to the transparent conductive layer, wherein the signal generator is configured to transmit the electrical signal to electrochromic layer via the transparent conductive layer; and
an additional signal generator coupled to a radio-frequency (RF) coupler, wherein the additional signal generator is configured to transmit an RF signal to the metal mesh via the RF coupler.

10. The optical device of claim 1, further comprising:
a signal generator coupled to the transparent conductive layer, wherein the signal generator is configured to transmit the electrical signal to the electrochromic layer via the transparent conductive layer;
an additional signal generator coupled to the transparent conductive layer, wherein the additional signal generator is configured to transmit an RF signal to the metal mesh via the transparent conductive layer;
a filter component coupled between the signal generator and the transparent conductive layer, wherein the filter component is configured to decouple the signal generator from the RF signal; and
an additional filter component coupled between the additional signal generator and the transparent conductive layer, wherein the additional filter component is configured to decouple the additional signal generator from the electrical signal.

11. The optical device of claim 10, wherein:
the filter component comprises an inductor; and
the additional filter component comprises a capacitor.

12. The optical device of claim 1, wherein:
the metal mesh comprises a center region and a perimeter region; and
the metal mesh exhibits a gradation of mesh density from the center region to the perimeter region.

13. The optical device of claim 1, further comprising:
an additional transparent conductive layer coupled to the electrochromic layer opposite the transparent conductive layer, wherein the additional transparent conductive layer is configured to convey light and provide electrical conductivity; and
an additional metal mesh coupled to the additional transparent conductive layer, wherein the additional metal mesh is configured to serve as an additional antenna.

14. The optical device of claim 1, wherein the transparent conductive layer comprises an indium tin oxide (ITO) layer.

15. The optical device of claim 1, further comprising:
a head-mounted display dimensioned to be worn by a user; and
an optical stack coupled to a frame of the head-mounted display, the optical stack comprising the transparent conductive layer, the metal mesh, the electrochromic layer, and at least one lens; and
wherein the metal mesh comprises a solid perimeter positioned to at least partially align with the frame of the head-mounted display such that the solid perimeter is at least partially obfuscated from view of the user when the head-mounted display is worn by the user.

16. The optical device of claim 15, wherein the optical stack further comprises a busbar that electrically couples the transparent conductive layer to the electrochromic layer, the busbar comprising a carbon-based substance that exhibits resistance to oxidation.

17. The optical device of claim 15, wherein the optical stack further comprises a busbar that electrically couples the transparent conductive layer to the electrochromic layer, the busbar comprising a silver contact at least partially encased by a protective mold.

18. A system comprising:
a head-mounted display dimensioned to be worn by a user; and
an optical device coupled to the head-mounted display, the optical device comprising:
an electrochromic layer configured to modify at least one optical characteristic in response to an electrical signal;
a transparent conductive layer coupled to the electrochromic layer, wherein the transparent conductive layer is configured to convey light and provide electrical conductivity; and
a metal mesh coupled to the transparent conductive layer, wherein the metal mesh is configured to serve as an antenna.

19. The optical device of claim 18, wherein the transparent conductive layer is coupled between the electrochromic layer and the metal mesh.

20. A method comprising:
coupling an electrochromic layer to a signal generator such that the electrochromic layer modifies at least one optical characteristic in response to an electrical signal provided by the signal generator;
coupling, to the electrochromic layer, a transparent conductive layer that conveys light and provides electrical conductivity to the electrochromic layer; and
coupling, to the transparent conductive layer, a metal mesh that serves as an antenna.
